(19) United States
(12) Patent Application Publication
(10) Pub. No.: US 2018/0260539 A1
(43) Pub. Date: Sep. 13, 2018

(54) DEVICE SPECIFIC IDENTITY LINKED TO USER ACCOUNT

(71) Applicant: Microsoft Technology Licensing, LLC, Redmond, WA (US)

(72) Inventors: Namrata Shankar PURI, Redmond, WA (US); Hakki Tunc BOSTANCI, Redmond, WA (US); Siddharth MANTRI, Redmond, WA (US)

(21) Appl. No.: 15/453,359

(22) Filed: Mar. 8, 2017

(51) Int. Cl. G06F 21/12; H04L 29/06

(52) U.S. Cl. CPC G06F 21/121; G06F 2221/0704; H04L 63/083

(57) ABSTRACT

Methods and devices for activating an operating system license on a computer device may include accessing a service associated with a user account for digital entitlement management, wherein the user account is associated with a device identification of the computer device. The methods and devices may include receiving a list of devices associated with the user account with available digital entitlements to be reactivated on the computer device or transferred to the computer device. The methods and devices may include receiving a selection of a device from the list of devices and sending an operating system license request to transfer the digital entitlement associated with the selected device from the selected device to the computer device. The methods and devices may include receiving an operating system license for the digital entitlement when the transfer of the digital entitlement is valid and activating the operating system on the computer device.

### BACKGROUND

The present disclosure relates to reactivating operating system licenses on a computer device.

In some operating systems (OSs), such as but not limited to MICROSOFT WINDOWS 7 and WINDOWS 8.x operating systems, every device required a unique 5×5 product key for activation. An algorithm on the client device was used to determine the hardware identity (HWID) of the device, which was based on certain hardware parameters of the device. The unique product key was bound to the client generated HWID on Activation and Validation Service (AVS) upon successful activation. If the same device required reactivation, either due to hardware change or a clean install of the OS, hardware tolerance was evaluated by AVS by comparing the current HWID to the HWID bound to product key on the service. If hardware parameters of the device did not undergo a significant change, that is if the HWID was within tolerance, reactivation of the OS would occur seamlessly. If hardware parameters of the device changed significantly, such that the HWID of the device changed, then HWID would be considered out of tolerance and reactivation of the OS would fail.

However, in some operating systems, when a HWID of a device went out of tolerance, there was a process by which users could get an override to their product key. A user would select phone activation and contact support, which would be redirected to an Interactive Voice Response (IVR) system or an agent. A 63-digit installation ID (IID), which was derived from the product key and certain hardware characteristics of the device, would be displayed to the user. The user would have to punch in these 63 digits, 7 digits at a time, into the IVR system. The IVR system would send the IID to AVS for verification. Additionally, the user would be asked a question, “On how many devices is this key being used?” If the user response was “1,” the IVR system would allow the user to proceed. After verification by AVS, AVS would compute a 25-digit confirmation ID (CID), if reactivation was permitted. Additionally, AVS would bind the unique product key to the new HWID of the device. AVS would return the CID to the user through the IVR system. Once the user entered the CID into the device, an OS licensing stack (e.g., the MICROSOFT Software Protection Platform Service (SPPSVC)) would validate the CID and activate the device.

In some newer OSs, such as but not limited to MICROSOFT WINDOWS 10, when a device goes through the free upgrade from an older OS (e.g., MICROSOFT WINDOWS 7 or WINDOWS 8.x), there is no unique product key given per device for activation. Instead, free WINDOWS 10 OS upgrades are licensed through an on-line service, that is, a digital entitlement for the HWID and OS edition for the device is created in an account (e.g., a MICROSOFT Account (MSA)) maintained by the service. This HWID is calculated by the service for the account and is configured to have a tolerance limit.

If hardware parameters of the device did not undergo a significant change, the HWID would remain the same. Upon receiving reactivation request, the digital entitlement bound to HWID and OS edition for the account would be valid and would provide an OS license to the device for seamless activation. If hardware parameters of the device changed significantly, such that the HWID of the device changed, the HWID would be considered out of tolerance and reactivation of the OS would fail. In MICROSOFT WINDOWS 10, this scenario occurs only in the case of motherboard replacement.

Unlike earlier OSs, such as MICROSOFT WINDOWS 7 and WINDOWS 8.x, where a product key was used to establish a proof of ownership of the OS to help in reactivation, there is no such proof of ownership in newer OSs, such as MICROSOFT WINDOWS 10.

Thus, there is a need in the art for improvements in reactivating operating system licenses on computer devices.

### SUMMARY

The following presents a simplified summary of one or more implementations of the present disclosure in order to provide a basic understanding of such implementations. This summary is not an extensive overview of all contemplated implementations, and is intended to neither identify key or critical elements of all implementations nor delineate the scope of any or all implementations. Its sole purpose is to present some concepts of one or more implementations of the present disclosure in a simplified form as a prelude to the more detailed description that is presented later.

One example implementation relates to a computer device comprising a memory to store data and instructions and a processor in communication with the memory. The computer device also includes an application and a license manager component in communication with the memory and the processor operable to access a service associated with a user account for digital entitlement management, wherein the user account is associated with a device identification of the computer device, receive a list of devices associated with the user account with available digital entitlements to be reactivated on the computer device or transferred to the computer device, receive a selection of a device from the list of devices, send an operating system license request to transfer the digital entitlement associated with the selected device from the selected device to the computer device, receive an operating system license for the digital entitlement when the transfer of the digital entitlement is valid, and activate the operating system license on the computer device.

Another example implementation relates to a method for activating an operating system license on a computer device. The method may include accessing, via an application in communication with a memory and a processor on the computer device, a service associated with a user account for digital entitlement management, wherein the user account is associated with a device identification of the computer device. The method may also include receiving, at the application, a list of devices associated with the user account with available digital entitlements to be reactivated on the computer device or transferred to the computer device. The method may include receiving, at the application, a selection of a device from the list of devices. The method may also include sending, via a license manager component in communication with the memory and the processor on the computer device, an operating system license request to transfer the digital entitlement associated with the selected device from the selected device to the computer device. The method may include receiving, at the license manager component, an operating system license for the digital entitlement when the transfer of the digital entitlement is valid. In addition, the method may include activating, via the license manager component, the operating system license on the computer device.

Another example implementation relates to a server comprising a memory to store data and instructions and a processor in communication with the memory. The server may also include a user account manager and a digital entitlement manager in communication with the memory and the processor operable to receive a request from a computer device to access a service associated with a user account for digital entitlement management, wherein the user account is associated with a device identification of the computer device, accessing the user account associated with the device identification of the computer device, retrieving a list of devices associated with the user account with available digital entitlements to be reactivated on the computer device or transferred to the computer device, transmitting the list of devices to the computer device, receiving an operating system license request to transfer a digital entitlement associated with a selected device identification from the list of devices to the computer device, determining whether the transfer of the digital entitlement is valid, generating an operating system license associated with the digital entitlement when the transfer is valid, and transmitting the operating system license to the computer device.

Additional advantages and novel features relating to implementations of the present disclosure will be set forth in part in the description that follows, and in part will become more apparent to those skilled in the art upon examination of the following or upon learning by practice thereof.

### DESCRIPTION OF THE FIGURES

In the drawings:

FIG. 1 is a schematic block diagram of an example system including a device-specific identity linked to a user account, in accordance with an implementation of the present disclosure;

FIG. 2 is a flow chart of a method for reactivating an operating system license on a computer device in accordance with an implementation of the present disclosure;

FIG. 3 is a flow chart of a method for transferring an operating system license in accordance with an implementation of the present disclosure;

FIG. 4 is a message flow diagram of a method for reactivating an operating system license on a computer device in accordance with an implementation of the present disclosure;

FIG. 5 is a schematic block diagram of an example device in accordance with an implementation of the present disclosure;

FIG. 6 is a schematic block diagram of an example server in accordance with an implementation of the present disclosure; and

FIGS. 7A-7F are example user interface screens in accordance with an implementation of the present disclosure.

### DETAILED DESCRIPTION

The present disclosure provides systems and methods for reactivating an operating system license on a computer device and/or transferring an operating system license from one computer device to another computer device. An operating system license may need to be reactivated, for example, either due to hardware changes on the computer device or a clean install of the operating system on the computer device. The systems and methods may associate a user account with a digital entitlement for the HWID and an OS edition for the device. The digital entitlement may be a digital license associated with an operating system license for one or more devices. In addition, the digital entitlements may be stored in a data repository that associates the HWID of a computer device and license eligibility of the HWID. For example, a computer device (identified by a particular HWID), or a user (identified by a user account) may be entitled to a digital license of the OS when the HWID of the computer device is associated with a digital entitlement in the data repository. A user account may be associated with a plurality of devices and/or a plurality of digital entitlements. The systems and methods may allow a user to register a digital entitlement with a user account. For example, a user may be allowed to register one or more digital entitlements with a user account. The system and methods may also allow a user to reactive a digital entitlement on a computer device using the user account. In addition, the systems and methods may allow a user to reassign and/or transfer a digital entitlement from one computer device to another compute device using the user account.

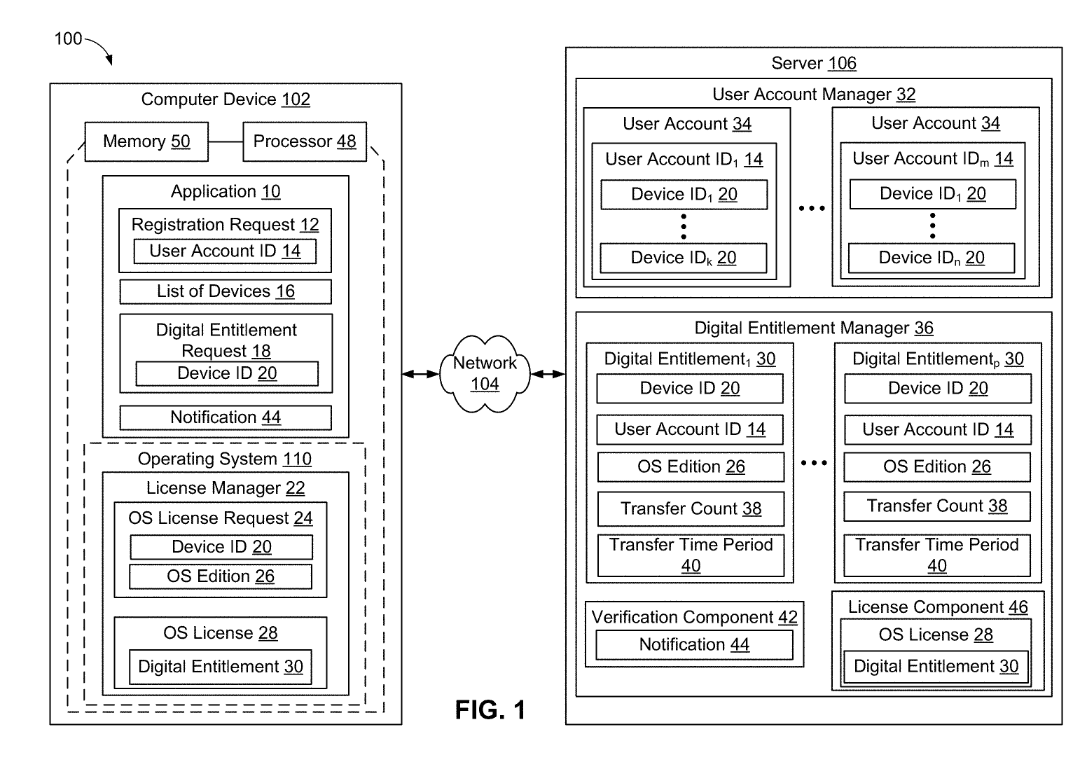

Referring now to FIG. 1, an example computer device 102 where an operating system license may need to be reactivated and/or transferred may include an operating system 110 executed by processor 48 and/or memory 50 of computer device 102. Memory 50 of computer device 102 may be configured for storing data and/or computer-executable instructions defining and/or associated with operating system 110, and processor 48 may execute operating system 110. An example of memory 50 can include, but is not limited to, a type of memory usable by a computer, such as random access memory (RAM), read only memory (ROM), tapes, magnetic discs, optical discs, volatile memory, non-volatile memory, and any combination thereof. An example of processor 48 can include, but is not limited to, any processor specially programmed as described herein, including a controller, microcontroller, application specific integrated circuit (ASIC), field programmable gate array (FPGA), system on chip (SoC), or other programmable logic or state machine.

Computer device 102 may include any mobile or fixed computer device, which may be connectable to a network. Computer device 102 may be, for example, a computer device such as a desktop or laptop or tablet computer, a cellular telephone, a gaming device, a mixed reality or virtual reality device, a music device, a television, a navigation system, a camera, a personal digital assistant (PDA), or a handheld device, or any other computer device having wired and/or wireless connection capability with one or more other devices.

Computer device 102 may also include one or more applications 10 that enables a user to access a service provided by server 106 and establish a new user account 34, e.g., a managed service account, having a user account identifier (ID) 14 for accessing the service. For example, when a user activates computer device 102, e.g., during an initialization of computer device 102, application 10 may receive a prompt for the user to register computer device 102 with a service, such as but not limited, managing a digital entitlement 30 associated with a user account 34. Application 10 may send a registration request 12 to server 106 with a user account ID 14 to establish a new user account 34.

Server 106 may have a user account manager 32 that may establish a new user account 34 for the received user account ID 14. User account manager 32 may also associate the user account ID 14 with a device ID 20 of computer device 102. User account ID 14 may include, for example, a username and password that enables access to user account 34. In addition, user account ID 14 may include a number that may be linked to a username and password that enables access to user account 34.

Application 10 may also allow a user to access server 106 to associate an existing user account 34 with a device ID 20 of computer device 102. For example, application 10 may send a registration request 12 with a user account ID 14 to server 106 to register a user account 34 associated with the user account ID 14 with computer device 102. An example user account 34 may include a MICROSOFT Account (MSA). User account manager 32 may update user account 34 to include device ID 20 of computer device 102. In addition, if a user owns a plurality of computer devices, each device ID 20 that corresponds to the various computer devices owned by the user may be associated with the user account 34 associated with the user.

As such, application 10 may be used by a user to establish and maintain a user account 34 associated with accessing one or more services provided by server 106, such as, but not limited to, managing a digital entitlement 30 for computer device 102. In addition, user account 34 may be used to establish ownership of operating system license 28, which may be associated with a digital entitlement 30, operating on computer device 102.

Server 106 may also include a digital entitlement manager 36 operable to manage one or more digital entitlements 30 associated with a plurality of computer devices 102. Each digital entitlement 30 may be associated with one or more device IDs 20, one or more user account IDs 14, and an operating system edition 26 (e.g., a version of the operating system). In addition, each digital entitlement 30 may include a transfer count 38 that may be incremented each time the digital entitlement 30 is transferred to another computer device and/or reactivated on computer device 102. Each digital entitlement 30 may also include a transfer time period 40 that tracks a period of time (e.g., a number of days) since the activation of digital entitlement 30.

Application 10 may also allow a user to reactivate a digital entitlement 30 on computer device 102 and/or transfer a digital entitlement 30 from another computer device to computer device 102. Application 10 may allow a user to sign into user account 34 by, for example, providing a user name and password. Application 10 may also prompt the user to answer other security questions before allowing the user access to services for managing the digital entitlement 30 associated with computer device 102. In an implementation, a dual factor authentication of the user may be required.

There may be a plurality of user accounts 34 associated with computer device 102. For example, there may be one or more administrative user accounts 34 that may be able to manage the digital entitlement 30 of computer device 102. Managing a digital entitlement 30 may include, but is not limited to, reactivating a digital entitlement 30 on computer device 102 and/or transferring digital entitlement 30 from another computer device to computer device 102. In an implementation, once an administrative user account 34 reactivates a digital entitlement 30 on computer device 102 and/or reassigns a digital entitlement 30 to computer device 102, other administrative user accounts 34 associated with computer device 102 may lose a reassignment right for that particular digital entitlement 30.

For example, upon a user signing into user account 34, application 10 may receive from user account manager 32, a list of devices 16 associated with user account ID 14. User account manager 32 may transmit a list of devices 11 associated with user account 34 to application 10, for example, in order to assist a user in identifying a device to associate with a reactivated or transferred digital entitlement 30. Application 10 may present a list of devices 11 associated with the user account 34. The list of devices 11 may include one or more devices associated with user account 34. In addition, the list of devices 11 may not include any devices if devices are not associated with user account 34. For example, in order to associate computer device 102 with the reactivated and/or transferred digital entitlement 30, a user may select a device corresponding to computer device 102 from the list of devices 11. Application 10 may send a digital entitlement request 18 with the device ID 20 of the selected device to license manager 22 to transfer the digital entitlement 30 associated with the selected device ID 20 to computer device 102 and/or reactivate the digital entitlement 30 on computer device 102.

License manager 22 may send an operating system license request 24 to server 106 to reactivate and/or transfer the digital entitlement 30 associated with the selected device ID 20 to computer device 102. Operating system license request 24 may include, for example, the device ID 20 of the selected device and an operating system edition 26.

Digital entitlement manager 36 may identify the digital entitlement 30 associated with the received device ID 20. In addition, digital entitlement manager 36 may include a verification component 42 that may execute one or more verification rules to verify whether digital entitlement 30 may be reactivated on computer device 102 and/or transferred to computer device 102 from another device. For example, verification component 42 may verify whether the operating system edition requested matches the operating system edition 26 of digital entitlement 30. When a match occurs, digital entitlement 30 may be able to be transferred and/or reactivated. When a match does not occur, digital entitlement 30 may not be able to be transferred and/or reactivated.

For example, the digital entitlement 30 transfer and/or reactivation may be invalid if a user-based throttle vector limit is reached, an entitlement-based throttle vector limit is reached, a device-based throttle vector limit is reached, and/or a user does not have devices associated with the user account 34. For example, verification component 42 may compare a transfer count 38 associated with digital entitlement 30 with a predetermined number of transfers allowed for the digital entitlement 30. If the transfer count 38 is at or below the predetermined number of transfers allowed, verification component 42 may verify that the digital entitlement 30 transfer is valid. When the transfer count 38 exceeds the predetermined number of transfers allowed, verification component 42 may determine that the digital entitlement 30 is not valid. Verification component 42 may also compare a transfer time period 40 with a predetermined allowed time period between transfers. If the transfer time period 40 is below the predetermined allowed time period between transfers, verification component 42 may determine that the digital entitlement 30 transfer is not valid. However, if the transfer time period 40 is at or above the predetermined allowed time period, verification component 42 may determine that the digital entitlement 30 transfer is valid.

In the case of a failed verification, for example, verification component 42 may send a notification 44 to license manager 22 rejecting the operating system request for the reactivation of digital entitlement 30 on computer device 102 and/or rejecting the transfer of digital entitlement 30 to computer device 102. License manager 22 may transmit a notification 44 to application 10 indicating that the operating system license request 24 was denied. Application 10 may present notification 44 to the user indicating that the operating system license request 24 was denied. Notification 44 may include one or more reasons for the denial of the operating system license request 24 (e.g., a user exceeded a number of requests for license transfers within a time period).

In the case of a successful verification, for example, digital entitlement manager 36 may update the information associated with digital entitlement 30. For example, digital entitlement manager 36 may update the device ID 20 associated with digital entitlement 30. In addition, digital entitlement manager 36 may update a transfer count 38 associated with the digital entitlement 30 (e.g., increase transfer count 38). Digital entitlement manger 36 may also update a transfer time period 40 for digital entitlement 30. For example, the transfer time period 40 may be restarted when the transfer and/or reactivation occurs.

In addition, digital entitlement manager 36 may have a license component 46 that generates an operating system license 28 associated with digital entitlement 30 and transmits operating system license 28 to computer device 102.

Upon receiving operating system license 28 from server 106, license manager 22 may activate the operating system license 28 on computer device 102. Application 10 may receive a notification from license manager 22 that the license transfer and/or reactivation was successful. Application 10 may present a notification 44 to a user that the operating system license 28 is now operating on computer device 102. Notification 44 may include, but is not limited to, a graphic, watermark, sound, or any user-perceivable output.

One example use case includes an operating system reactivation for single user device. For example, a user upgrades a Windows 7 Lenovo laptop to Windows 10 using a free upgrade offer. However, one day the motherboard of the laptop becomes nonfunctional. The laptop is not within a warranty from Lenovo, so the user decides to change the motherboard by himself When the user restarts the device, and after going through an initialization process, the device lands in a non-activated state (e.g., an operating system is not active on the laptop). The user may be redirected from application 10 to an activation page associated with a service provided by server 106. The service may provide the user an option to reactivate the operating system upon hardware change. The user may sign into the service using his user account 34 information (e.g., username and password) and may select his device from a list of devices 16 assigned to his user account 34. Upon confirmation that the selected device is the same as the current device, the user's laptop (via execution of application 10 and license manager 22 interacting with user account manager 32 and digital entitlement manager 36 of server 106, as describe above) may seamlessly activate and the user may be able to continue using his Windows 10 laptop without any interruptions.

Another example use case includes an operating system reactivation for a multi user device. For example, John upgraded his home Windows 7 Dell desktop to Windows 10 using Microsoft's free upgrade offer. He associated his user account 34 (e.g., MSA) with the device when he went through an initialization process. John's wife Jill also uses this desktop and so John makes Jill an administrator on the device. When Jill logs into the desktop, she sees a notification to assign her user account 34 (e.g., MSA) for managing the Windows 10 license and happily does so. However, one day the motherboard of the desktop becomes nonfunctional. John is out on a business trip and Jill decides to change the motherboard. Jill goes to a store and purchases a new motherboard, which she replaces with the current one. She restarts the device and after going through an initialization process, the desktop lands in a non-activated state. Jill remembers a tool for reactivation after hardware changes. She may be redirected from application 10 to the Activation page associated with a service provided by server 106. The service may provide an option to reactivate the OS upon hardware change. She selects the option, signs in with her user account 34 (e.g., MSA), goes through two factor authentication and selects this desktop from the list of devices assigned to her MSA. Upon confirmation that the selected device is the same as the current device (via execution of application 10 and license manager 22 interacting with user account manager 32 and digital entitlement manager 36 of server 106, as describe above), the desktop seamlessly activates.

Another example use case may include preventing piracy of operating system licenses. For example, Harry owns a malicious OEM business and is trying to find new ways by which he can pirate operating systems and make money. Harry comes across a blog about OS reactivation after hardware change and thinks he can leverage this solution to pirate the OS by purchasing one copy of the OS and transferring it endlessly to a chain of devices. Very excitedly, Harry goes to a store and purchases a copy of the OS, which he installs on one device. He associated his user account 34 (e.g., a MSA) with the device when he went through an initialization process. He creates a bunch of bare metal devices and is all ready to begin pirating the OS (or so he thinks). He successfully reassigns the operating system license 28 from his current device to the new bare metal device using application 10. Application 10 may provide access to a service provided by server 106, such as an OS reactivation self-serve tool, during the Settings Activation experience. Thrilled, he tries to reassign the operating system license 28 again to the next bare metal device. However, when he tries to do so, he sees a message on his screen that the operating system license 28 has reached its reactivated limit and he should try again after 90 days. He is exasperated by this and keeps attempting to reassign his license to the bare metal device over and over again. After 10 attempts, he sees that his MSA is blocked for OS reactivation.

Yet another use case may include reactivation rights lost after a transfer of an operating license and a transfer not being allowed for users who did not previously register their operating system license to their user account. For example, John upgraded his home Windows 7 Dell desktop to Windows 10 using Microsoft's free upgrade offer. He associated his user account 34, e.g., MSA, with the computer device 102 when he went through an initialization process. John's wife Jill also uses this desktop and so John makes Jill an administrator on the device. When Jill logs into the desktop, she sees a notification to assign her MSA for managing the Windows 10 license and happily does so. However, one day the motherboard of the desktop gets becomes non-functional. John is out on a business trip and Jill decides to change the motherboard. Jill goes to a store and purchases a new motherboard, which she replaces with the current one. She restarts the device and, after going through an initialization process, the desktop lands in a non-activated state. Jill remembers a tool for reactivation after hardware changes. She may be redirected from application 10 to the Activation page associated with a service provided by server 106. She sees an option to reactivate the OS upon hardware change. She selects the option, signs in with her user account 34 (e.g., MSA), goes through two factor authentication and selects this desktop from the list of devices assigned to her MSA. Upon confirmation that the selected device is the same as the current device (via execution of application 10 and license manager 22 interacting with user account manager 32 and digital entitlement manager 36 of server 106, as describe above), the desktop seamlessly activates. However, Jill forgets to add John back as an administrator on the device. John disregards the notification and Settings Activation experience accessed by application 10 requesting him to elevate to administrator privilege and associate his user account 34 (e.g., MSA) with the device to manage the Windows 10 license. A year later, the desktop's motherboard again becomes non-functional. John decides to change the motherboard and purchases a new one, which he replaces with the current one. He restarts the device and after going through an initialization process, the desktop lands in a non-activated state. He may be redirected from application 10 into the Activation page in Settings. He sees an option to reactivate the OS upon hardware change. He selects the option, signs in with his MSA and goes through two factor authentication. However, John does not see an option to transfer license from the current device. John sees an option in the tool to call an employee of the operating system provider and the employee walks John through the recovery path for restoring activation of the device and associating MSA with the Windows 10 license for future use.

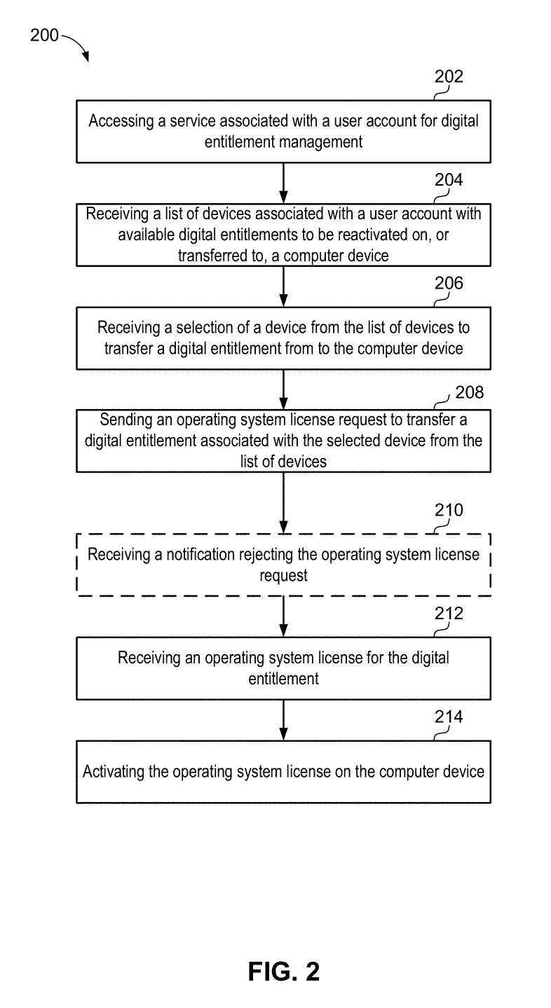

Referring now to FIG. 2, an example method 200 enables reactivating a digital entitlement for, or transferring a digital entitlement to, computer device 102 via association of the digital entitlement with a user account. For example, method 200 may be used for reactivating a digital entitlement on computer device 102 may be executed by computer device 102 when, for example, a clean install of the operating system is required on computer device 102 and/or a significant hardware change occurred on computer device 102, such as a motherboard replacement. In addition, for example, method 200 may be used to transfer a digital entitlement from another device to computer device 102.

At 202, method 200 may include accessing a service associated with a user account for digital entitlement management. Digital entitlement management may include, but is not limited to, registering a digital entitlement 30 with a user account 34, reactivating a digital entitlement 30 on computer device 102, and/or transferring a digital entitlement 30 from another computer device to computer device 102. For example, a user may use application 10 (FIG. 1) to access one or more services provided by server 106, such as, but not limited to, digital entitlement management. Server 106 may allow a user to sign into the user account 34 by supplying, for example, a user name and a password for user account 34.

User account 34 may include, for example, a MSA. Application 10 may also prompt the user to answer other security questions before allowing the user access to the digital entitlement management service. In an implementation, a dual factor authentication of the user may occur prior to providing the user access to the digital entitlement management service. There may be a plurality of user accounts 34 associated with computer device 102. Once an administrative user account 34 reactivates a digital entitlement 30 on computer device 102 and/or reassigns a digital entitlement 30 to computer device 102, other administrative user accounts 34 associated with computer device 102 may lose a reassignment right for that particular digital entitlement 30.

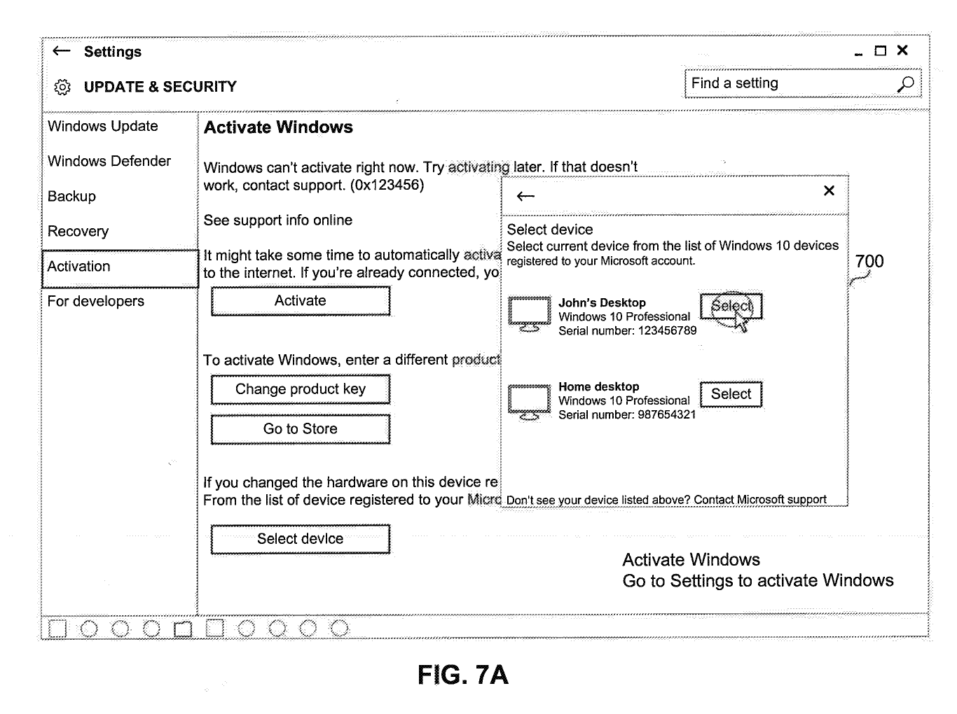

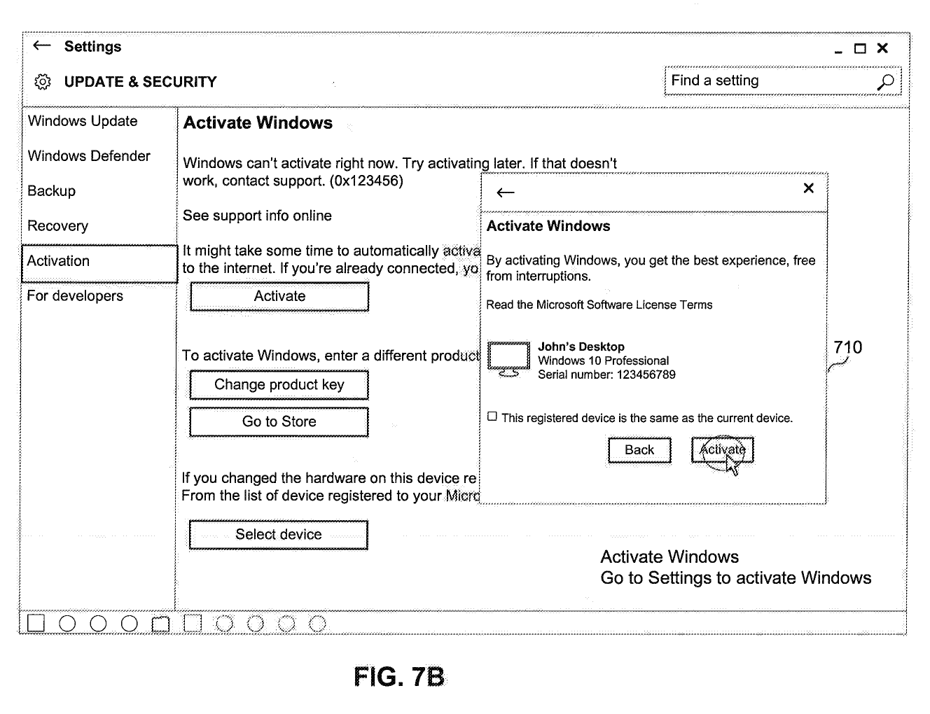

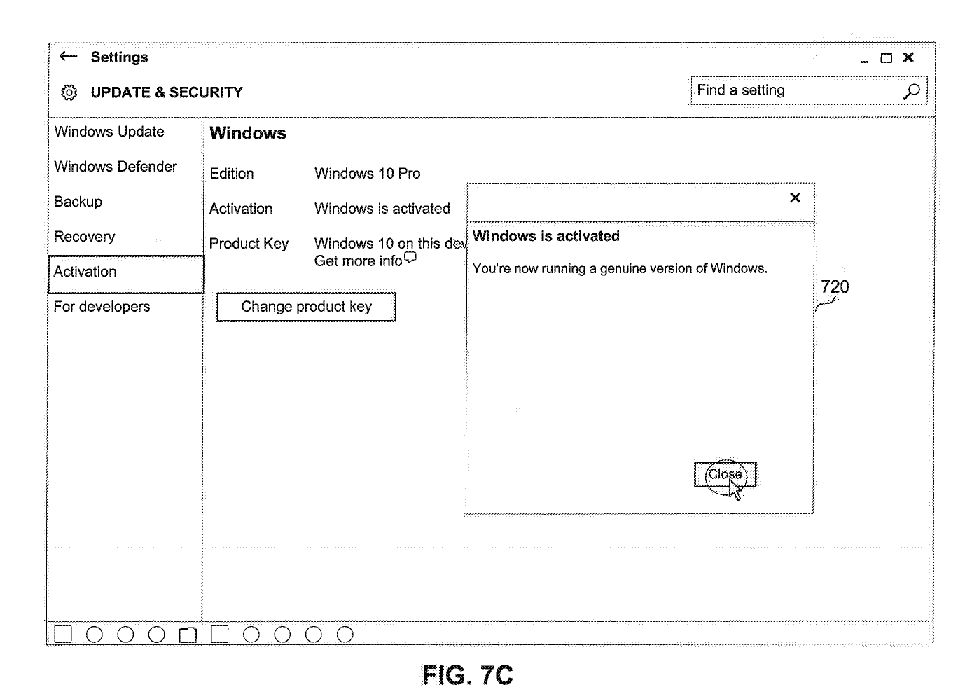

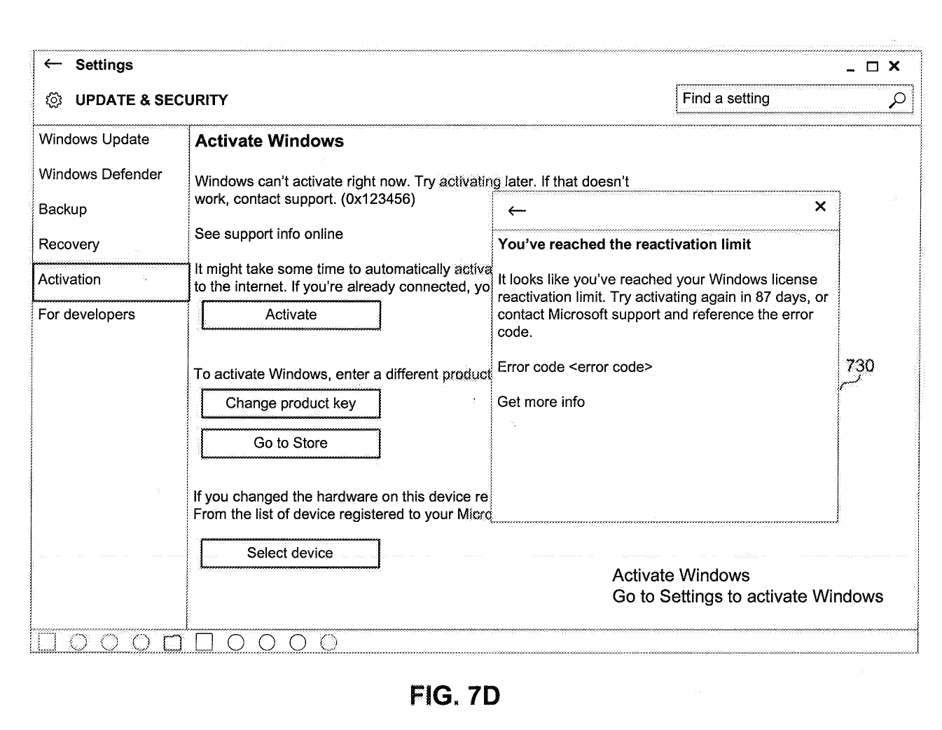

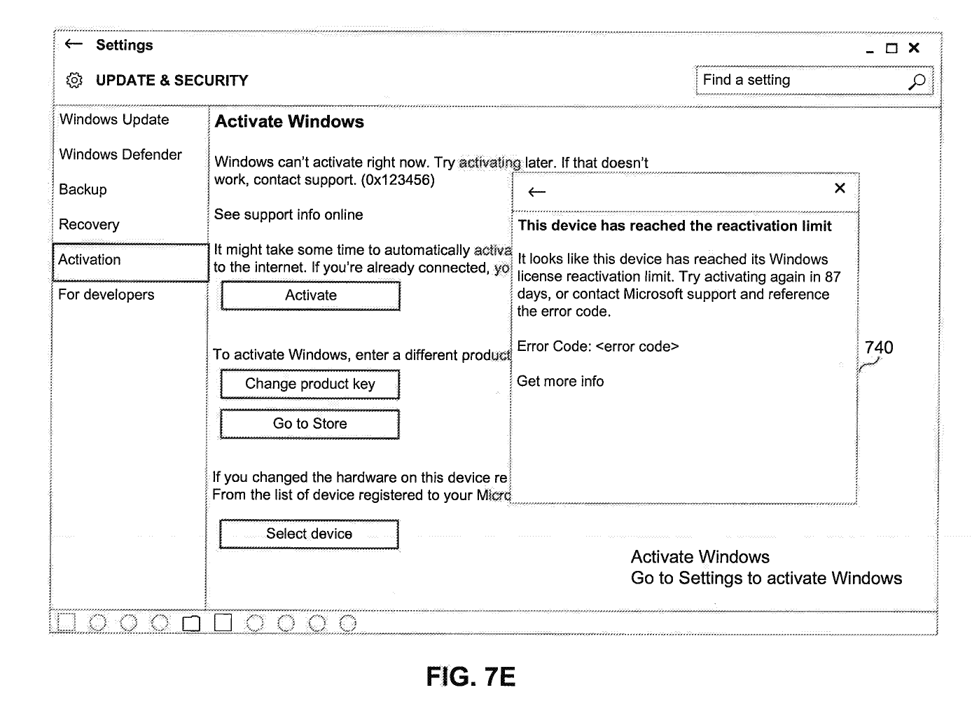

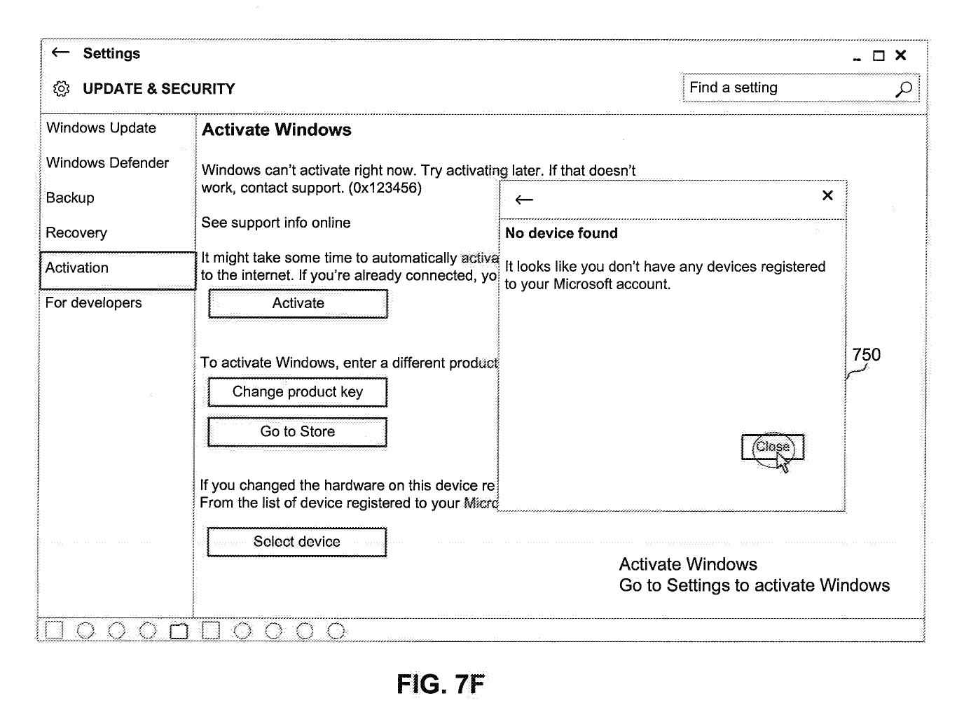

At 204, method 200 may include receiving a list of devices associated with a user account with available digital entitlements to be reactivated on, or transferred to, a computer device. Application 10 may receive a list of devices 16 associated with user account 34 from user account manager 32 and may present the list of devices 11. The list of devices 11 may be filtered, for example, to include devices with the same form factor (e.g., laptop, desktop, tablet) and/or the same operating system edition 26 as computer device 102. FIG. 7A illustrates an example list of devices 700 a user may be presented with when selecting a device.

At 206, method 200 may include receiving a selection of a device from the list of devices to transfer a digital entitlement from to the computer device. Application 10 may receive a selection of a device, for example, from a user to transfer a digital entitlement 30 from to the computer device 102. The selected device may be the same device as computer device 102 or may be a different computer device associated with the user account 34. FIG. 7B illustrates an example selection of a device in accordance with an implementation.

At 208, method 200 may include sending an operating system license request to transfer a digital entitlement associated with the selected device from the list of devices. For example, licensing manager 22 may communicate with application 10 and receive the device ID 20 of the selected device from the list of devices 11. Licensing manager may transmit an operating system license request 24 to digital entitlement manager 36 to transfer and/or reassign the digital entitlement 30 associated with the device ID 20 of the selected device to computer device 102. The operating system license request 24 may include, for example, the device ID 20 of the selected device and the operating system edition 26 to server 106.

At 210, method 200 may optionally include receiving a notification rejecting the operating system request. For example, licensing manager 22 may receive a notification 44 from server 106 rejecting the operating system license request 24. Transfers of digital entitlements 30 may be denied, for example, when user based violations occur, entitlement based violations occur, and/or device based violations occur. An example user based violation may include a particular user attempting to reactivate a digital entitlement more than a predetermined number of times allocated for the user within a time period. For example, a user may try to reactive a digital entitlement more than four times within a year.

An example entitlement based violations may include a user attempting to reactivate a digital entitlement 30 before a predetermined time period expires. For example, ninety days may be required between every reactivation. When a user attempts to reactivate a digital entitlement 30 prior to ninety days, the request may be denied. Another example for an entitlement based violation may include when a request to reactive a digital entitlement 30 exceeds a predetermined number of reactivations allowed for the digital entitlement 30. For example, if a digital entitlement 30 may be reactivated two times and a user attempts to reactivate a digital entitlement 30 a third time, the request may be denied. In addition, if a digital entitlement 30 may be reactivated ten times by an employee of the OS provider, and a user requests the employee to reactivate the digital entitlement 30 an eleventh time, the request may be denied.

An example device based violation may include exceeding a predetermined number of digital entitlement 30 reactivations for a device ID. Application 10 may present a notification 44 to a user indicating that the operating system license request 24 was denied. Notification 44 may include, but is not limited to, a graphic, watermark, sound, or any user-perceivable output corresponding to the denial. Example notifications 730 and 740 are illustrated in FIGS. 7D and 7E.

At 212, method 200 may include receiving an operating system license for the digital entitlement. For example, license manager 22 may receive an operating system license 28 associated with digital entitlement 30 from digital entitlement manager 36 when digital entitlement manager 36 determines that the digital entitlement 30 transfer is valid. The digital entitlement transfer may be valid, for example, when the transfer is within a user based limit, such as a predetermined number of times a user may reactive and/or transfer digital entitlement 30. The digital entitlement transfer may also be valid, for example, when the transfer is within an entitlement based limit, such as a predetermined number of times the digital entitlement 30 may be transferred and/or a time period for transfer. In addition, the digital entitlement 30 transfer may be valid, for example, when the transfer is within a device based limit, such as a predetermined number of times a device may have a digital entitlement 30 reactivated. For example, if digital entitlement 30 may be reactivated two times and a user attempts to reactivate digital entitlement 30 for a first time, the digital entitlement transfer may be considered valid.

At 214, method 200 may include activating the operating system license on the computer device. License manager 22 may activate operating system license 28 on computer device 102. License manager 22 may also transmit a notification 44 to application 10 indicating that operating system license 28 is activated on computer device 102 and/or enable the computer device 102 to boot up. An example activation notification 720 is illustrated in FIG. 7C.

In an implementation, the selected device may maintain rights to execute digital entitlement 30 after the operating system license 28 is activated on computer device 102. In addition, the selected device may no longer have transfer rights to transfer digital entitlement 30 to another computer device.

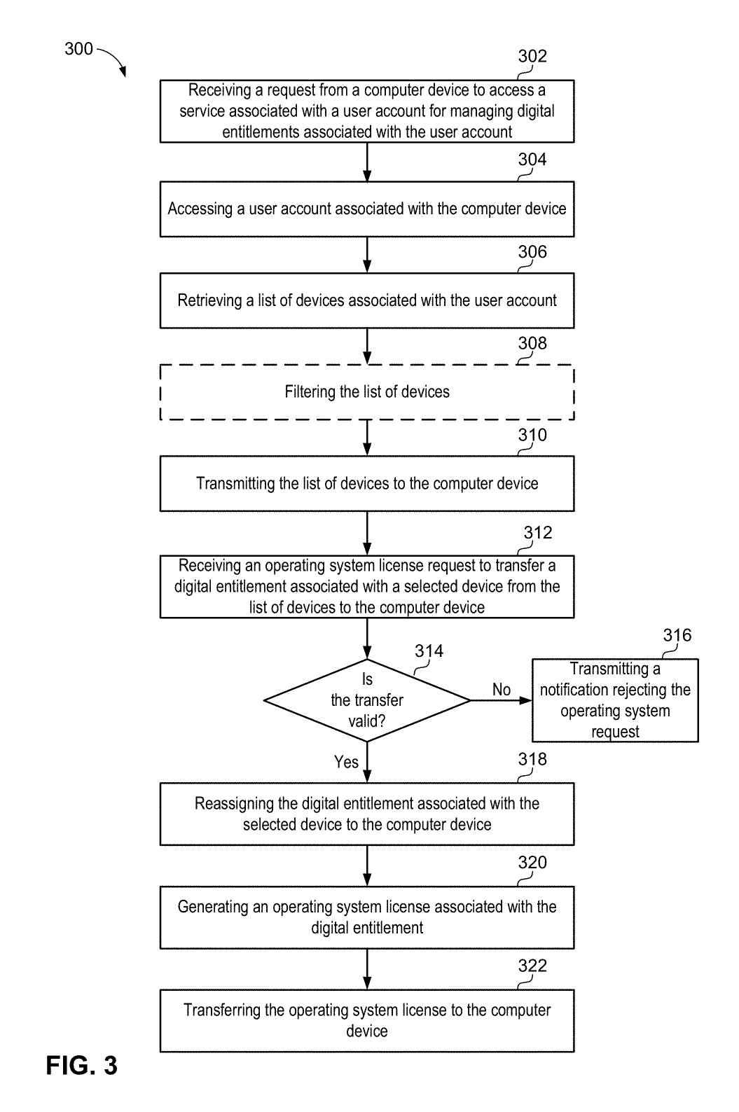

Referring now to FIG. 3, an example method 300 for reactivating or transferring a digital entitlement 30 (FIG. 1) may be executed by server 106 (FIG. 1), via association of the digital entitlement 30 with a user account 34, when a request is received to reactivate the digital entitlement 30 or transfer digital entitlement 30 from a device to computer device 102 (FIG. 1).

At 302, method 300 may include a receiving request from a computer device to access a service associated with a user account for managing digital entitlements associated with the user account. Managing digital entitlements may include, but is not limited to, associating a digital entitlement 30 with user account 34, reactivating a digital entitlement 30 associated with user account 34, and/or transferring a digital entitlement 30 from one computer device associated with user account 34 to another computer device associated with user account 34.

At 304, method 300 may include accessing a user account associated with the computer device. For example, user account manager 32 may receive a username and password from application 10, and possible other identifying information, which if correct, links to a user account ID 14 associated with the user account 34. There may be a plurality of user accounts 34 associated with computer device 102. For example, there may be one or more administrative user accounts 34 that may be able to manage the digital entitlements 30 (FIG. 1) of computer device 102. In an implementation, once an administrative user account reactivates a digital entitlement 30, other administrative users accounts 34 associated with computer device 102 may lose the right to reassign the digital entitlement 30.

At 306, method 300 may include retrieving a list of devices associated with the user account. User account manager 32 may retrieve one or more device IDs 20 associated with user account ID 14.

At 308, method 300 may optionally include filtering the list of devices. For example, user account manager 32 may filter the list of devices based on an operating system edition (e.g., only devices with the same operating system edition as computer device 102 may be included in the list of devices). The list of devices may also be filtered by the same form factor (e.g., laptop, desktop, tablet). The filtered list of devices may include devices that are available to transfer a digital entitlement 30.

At 310, method 300 may include transmitting the list of devices to the computer device. For example, user account manager 32 may transmit the list of devices to computer device 102 and application 10 may present the list of devices 16 to a user on, for example, a display. If a user account 34 does not have device IDs 20 associated with the user account 34, then the list of devices 16 may not be transferred to the computer device 102. An example notification 750 indicating that devices are not associated with the user account is illustrated in FIG. 7F.

At 312, method 300 may include receiving an operating system request to transfer a digital entitlement associated with a selected device from the list of devices to the computer device. In an implementation, the operating system request may also include a request to reinstate a digital entitlement on the computer device. For example, digital entitlement manager 36 may receive an operating system license request 24 from license manager 22 to transfer a digital entitlement 30 from the selected device to computer device 102. In addition, digital entitlement manager 36 may receive an operating system license request 24 from license manager 22 to reinstate an existing digital entitlement 30 on the computer device 102. The operating system license request 24 may include a device ID 20 of the selected device or computer device 102 and an operating system edition 26 of the digital entitlement 30.

At 314, method 300 may include determining whether the operating system license transfer is valid. Digital entitlement manager 36 may include a verification component 42 operable to verify whether the digital entitlement 30 transfer and/or reactivation may be valid. For example, verification component 42 may access the digital entitlement 30 and may compare a transfer count 38 of the digital entitlement 30 with a predetermined number of transfers allowed for the digital entitlement 30. If the transfer count 38 is equal to or below the predetermined number of transfers allowed, verification component 42 may verify that the digital entitlement 30 transfer and/or reactivation is valid. When the transfer count 38 exceeds the predetermined number of transfers allowed, verification component 42 may determine that the digital entitlement 30 transfer and/or reactivation is not valid. Verification component 42 may also compare a transfer time period 40 with a predetermined time period between transfers. If the transfer time period 40 is below the predetermined time period between transfers, verification component 42 may determine that the digital entitlement 30 transfer and/or reactivation is not valid. However, if the transfer time period 17 is equal to or above the predetermined time period, verification component 42 may determine that the digital entitlement 30 transfer and/or reactivation is valid.

At 316, method 300 may include transmitting a notification rejecting the request for the license transfer. When verification component 42 determines that the digital entitlement 30 transfer and/or reactivation may not be valid, for example, when one or more of a user based violation, device based violation, and/or an entitlement based violation occurs, verification component 42 may transmit a notification 44 to computer device 102 denying the operating system license request 24. The notification 44 may include a reason for the denial. For example, notification 44 may indicate that the digital entitlement 30 has reached a reactivation limit and that the user may try again in 87 days.

At 318, method 300 may include reassigning the digital entitlement associated with the selected device to the computer device. When the digital entitlement 30 transfer and/or reactivation is valid, digital entitlement manager 36 may reassign the device ID associated with the digital entitlement 30 to the device ID 20 of computer device 102. In addition, digital entitlement manager 36 may increase a transfer count 38 (e.g., add one to the transfer count 38) when the digital entitlement 30 transfer occurs and/or update a transfer time period 40 for the digital entitlement 30 transfer (e.g., restart a transfer time period). For example, ninety days may be required between every reactivation of digital entitlement 30. When a user attempts to reactivate a digital entitlement 30 one hundred days after the digital entitlement 30 is activated, the reactivation of digital entitlement 30 may be valid.

At 320, method 300 may include generating an operating system license associated with the digital entitlement. For example, digital entitlement manager 36 may have a license component 46 that generates an operating system license 28 associated with digital entitlement 30.

At 322, method 300 may include transferring the operating system license to the computer device. For example, license component 46 may transmit operating system license 28 to computer device 102.

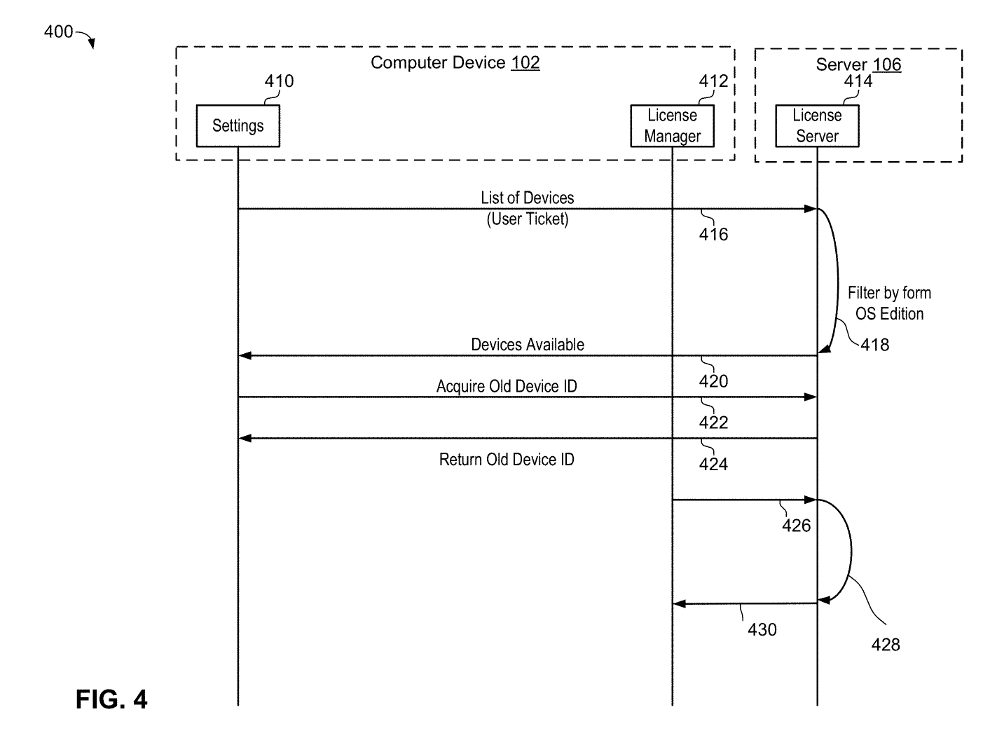

Referring now to FIG. 4, an example method 400 for an example use case where a user has or will setup a Microsoft Account and has already registered a plurality of computer devices with the Microsoft Account.

At 416, method 400 may include activating a start page from settings 410 via application 10 (FIG. 1). Application 10 (FIG. 1) may include, for example, a cloud host experience (CXH) and may present an interface to a user so that a user may enter in credentials (e.g., username and password) for a Microsoft Account that enables the user to connect to the Microsoft services and manage his account and associated services, including a digital entitlement reactivation and/or transfer service. For example, when an operating system license is not active on computer device 102, application 10 may present an option for the user to active an operating system license on computer device 102. The user may, for example, select a link to activate an operating system license on computer device 102.

When a user selects an option to activate an operating system license on computer device 102, settings 410 may send a request to license server 414 for a list of devices associated with the user account. License server 414 may include a user account manager 32 (FIG. 1) that accesses a user account ID 14 associated with the entered credentials and identifies a user account 34 associated with the user account ID 14. In an implementation, license server 414 may include a Device Directory Service (DDS).

At 418, license server 414 may filter the device list. For example, license server 414 may filter the device list to include devices with a same operating system edition and/or form factor as computer device 102.

At 420, license server 414 may transmit the filtered device list to settings 410. Application 10 may present a list of devices 16 (FIG. 1) to a user and may receive a selection of a device.

When a user selects the previous device identification of the computer device 102 from the device list, at 422, settings 410 may transmit a request to license server 414 to acquire the old device ID associated with the selected device. For example, license server 414 may retrieve the old device ID from user account manager 32. At 424, license server 414 may transmit the old device ID to settings 410.

At 426, licensing manager 412 may send an operating system license request 24 (FIG. 1) to license server 414. The operating system request 24 may include, for example, the old device ID for computer device 102. At 428, license server 414 may verify the operating system license request and create an operating system license 28 (FIG. 1) for computer device 102 and associate the operating system license 28 with the device ID of computer device 102. At 430, license server 414 may transmit the operating system license to licensing manager 412.

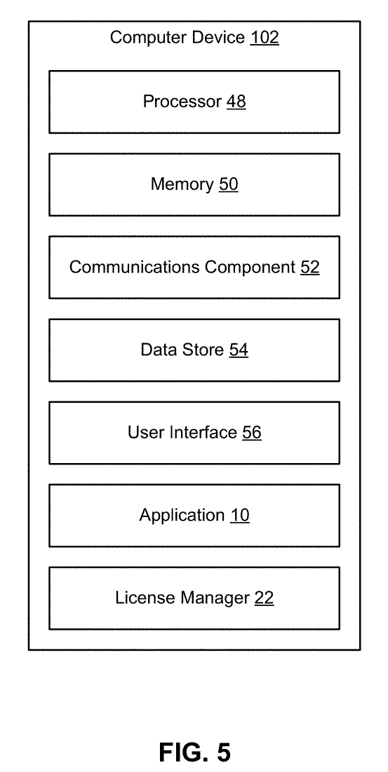

Referring now to FIG. 5, illustrated is an example computer device 102 in accordance with an implementation, including additional component details as compared to FIG. 1. In one example, computer device 102 may include processor 48 for carrying out processing functions associated with one or more of components and functions described herein. Processor 48 can include a single or multiple set of processors or multi-core processors. Moreover, processor 48 can be implemented as an integrated processing system and/or a distributed processing system.

Computer device 102 may further include memory 50, such as for storing local versions of applications being executed by processor 48. Memory 50 can include a type of memory usable by a computer, such as random access memory (RAM), read only memory (ROM), tapes, magnetic discs, optical discs, volatile memory, non-volatile memory, and any combination thereof

Further, computer device 102 may include a communications component 52 that provides for establishing and maintaining communications with one or more parties utilizing hardware, software, and services as described herein. Communications component 52 may carry communications between components on computer device 102, as well as between computer device 102 and external devices, such as devices located across a communications network and/or devices serially or locally connected to computer device 102. For example, communications component 52 may include one or more buses, and may further include transmit chain components and receive chain components associated with a transmitter and receiver, respectively, operable for interfacing with external devices.

Additionally, computer device 102 may include a data store 54, which can be any suitable combination of hardware and/or software, that provides for mass storage of information, databases, and programs employed in connection with implementations described herein. For example, data store 54 may be a data repository for applications 10 (FIG. 1) and/or license manager 22 (FIG. 1).

Computer device 102 may also include a user interface component 56 operable to receive inputs from a user of computer device 102 and further operable to generate outputs for presentation to the user. User interface component 56 may include one or more input devices, including but not limited to a keyboard, a number pad, a mouse, a touch-sensitive display, a navigation key, a function key, a microphone, a voice recognition component, any other mechanism capable of receiving an input from a user, or any combination thereof. Further, user interface component 56 may include one or more output devices, including but not limited to a display, a speaker, a haptic feedback mechanism, a printer, any other mechanism capable of presenting an output to a user, or any combination thereof.

In an implementation, user interface component 56 may transmit and/or receive messages corresponding to the operation of application 10 and/or license manager 22. In addition, processor 48 executes applications 10 and/or license manager 22, and memory 50 or data store 54 may store them.

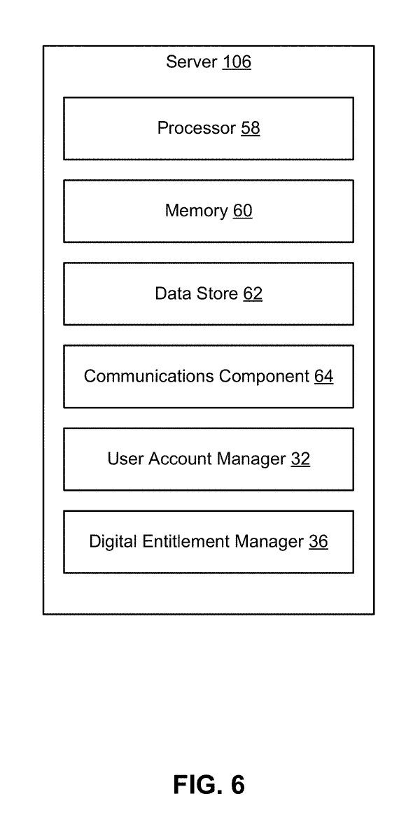

Referring now to FIG. 6, illustrated is an example server 106 in accordance with an implementation, including additional component details as compared to FIG. 1. In one example, server 106 may include processor 58 for carrying out processing functions associated with one or more of components and functions described herein. Processor 58 can include a single or multiple set of processors or multi-core processors. Moreover, processor 58 can be implemented as an integrated processing system and/or a distributed processing system.

Server 106 may further include memory 60, such as for storing local versions of applications being executed by processor 58. Memory 60 can include a type of memory usable by a computer, such as random access memory (RAM), read only memory (ROM), tapes, magnetic discs, optical discs, volatile memory, non-volatile memory, and any combination thereof.

Further, server 106 may include a communications component 64 that provides for establishing and maintaining communications with one or more parties utilizing hardware, software, and services as described herein. Communications component 64 may carry communications between components on server 106, as well as between server 106 and computer device 102 (FIG. 1) and/or server 106 and external devices, such as devices located across a communications network and/or devices serially or locally connected to server 106. For example, communications component 64 may include one or more buses, and may further include transmit chain components and receive chain components associated with a transmitter and receiver, respectively, operable for interfacing with external devices.

Additionally, server 106 may include a data store 62, which can be any suitable combination of hardware and/or software, that provides for mass storage of information, databases, and programs employed in connection with implementations described herein. For example, data store 62 may be a data repository for user account manager 32 (FIG. 1) and/or digital entitlement manager 36 (FIG. 1). In addition, processor 58 executes user account manager 32 and/or digital entitlement manager 36, and memory 60 or data store 62 may store them.

As used in this application, the terms “component,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computer device and the computer device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Furthermore, various implementations are described herein in connection with a device (e.g., computer device 102), which can be a wired device or a wireless device. A wireless device may be a cellular telephone, a satellite phone, a cordless telephone, a Session Initiation Protocol (SIP) phone, a wireless local loop (WLL) station, a personal digital assistant (PDA), a handheld device having wireless connection capability, a computer device, a mixed reality or virtual reality device, or other processing devices connected to a wireless modem.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Various implementations or features may have been presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

The various illustrative logics, logical blocks, and actions of methods described in connection with the embodiments disclosed herein may be implemented or performed with a specially-programmed one of a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computer devices, e.g., a combination of a DSP and a microprocessor, a plurality of microprocessors, one or more microprocessors in conjunction with a DSP core, or any other such configuration. Additionally, at least one processor may comprise one or more components operable to perform one or more of the steps and/or actions described above.

Further, the steps and/or actions of a method or algorithm described in connection with the implementations disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some implementations, the processor and the storage medium may reside in an ASIC. Additionally, the ASIC may reside in a user terminal. In the alternative, the processor and the storage medium may reside as discrete components in a user terminal. Additionally, in some implementations, the steps and/or actions of a method or algorithm may reside as one or any combination or set of codes and/or instructions on a machine readable medium and/or computer readable medium, which may be incorporated into a computer program product.

In one or more implementations, the functions described may be implemented in hardware, software, firmware, or any combination thereof If implemented in software, the functions may be stored or transmitted as one or more instructions or code on a computer-readable medium. Computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray disc where disks usually reproduce data magnetically, while discs usually reproduce data optically with lasers. Combinations of the above should also be included within the scope of computer-readable media.

While implementations of the present disclosure have been described in connection with examples thereof, it will be understood by those skilled in the art that variations and modifications of the implementations described above may be made without departing from the scope hereof. Other implementations will be apparent to those skilled in the art from a consideration of the specification or from a practice in accordance with examples disclosed herein.

1. A computer device, comprising:
memory configured to store data and instructions;
a processing system comprising at least one processor configured to be in communication with the memory;
an application and a license manager component configured to be in communication with the memory and the at least one processor, and operable to:
access a service associated with a user account that provides digital entitlement management for the computer device through the user account based at least on a device identification of the computer device changing or a clean install of the operating system occurring, wherein the user account is associated with a device identification of the computer device;
receive a list of devices associated with the user account with available digital entitlements to be reactivated on the computer device or transferred to the computer device, wherein the user account establishes ownership of the available digital entitlements;
receive a selection of a device from the list of devices;
send an operating system license request to transfer the digital entitlement associated with the selected device from the selected device to the computer device;
receive an operating system license for the digital entitlement when the transfer of the digital entitlement is valid; and
activate the operating system license on the computer device.

2. The computer device of claim 1, wherein the selected device is the computer device and wherein the operating system license request is for reactivating the digital entitlement on the computer device.

3. The computer device of claim 1, wherein digital entitlement management comprises one or more of registering digital entitlements with the user account, reactivating digital entitlements associated with the user account, and transferring digital entitlements associated with the user account.

4. The computer device of claim 1, wherein the transfer of the digital entitlement is valid when the transfer is within one or more of a predefined user based limit, a predefined entitlement based limit, or a predefined device based limit.

5. The computer device of claim 1, wherein the computer device has a plurality of user accounts associated with the computer device and the user account is one of the plurality of user accounts.

6. The computer device of claim 5, wherein when the operating system license is activated on computer device, other user accounts of the plurality of user accounts are restricted from transferring the operating system license associated with the computer device.

7. The computer device of claim 1, wherein the selected device maintains a right to execute the digital entitlement after the operating system license is activated on the computer device.

8. A method for activating an operating system license on a computer device includes:
accessing, via an application configured to be in communication with a memory and at least one processor on the computer device, a service associated with a user account that provides digital entitlement management for the computer devices through the user account based at least on a device identification of the computer device changing or a clean install of the operating system occurring, wherein the user account is associated with a device identification of the computer device;
receiving, at the application, a list of devices associated with the user account with available digital entitlements to be reactivated on the computer device or transferred to the computer device, wherein the user account establishes ownership of the available digital entitlements;
receiving, at the application, a selection of a device from the list of devices;
sending, via a license manager component in communication with the memory and the processor on the computer device, an operating system license request to transfer the digital entitlement associated with the selected device from the selected device to the computer device;
receiving, at the license manager component, an operating system license for the digital entitlement when the transfer of the digital entitlement is valid; and
activating, via the license manager component, the operating system license on the computer device.

9. The method of claim 8, wherein the selected device is the computer device and wherein the operating system license request is for reactivating the digital entitlement on the computer device.

10. The method of claim 8, wherein digital entitlement management comprises one or more of registering digital entitlements with the user account, reactivating digital entitlements associated with the user account, and transferring digital entitlements associated with the user account.

11. The method of claim 8, wherein the transfer of the digital entitlement is valid when the digital entitlement transfer is within one or more of a predefined user based limit, a predefined entitlement based limit, and a predefined device based limit.

12. The method of claim 8, wherein the computer device has a plurality of user accounts associated with the computer device and the user account is one of the plurality of user accounts.

13. The method of claim 12, wherein when the operating system license is activated on computer device, other user accounts of the plurality of user accounts are restricted from transferring the operating system license associated with the computer device.

14. The method of claim 8, wherein the selected device maintains a right to execute the digital entitlement after the operating system license is activated on the computer device.

15. A server, comprising:
a memory to store data and instructions;
a processing system comprising at least one processor configured to be in communication with the memory;
a user account manager and a digital entitlement manager configured to be in communication with the memory and the at least one processor, and operable to:
receive a request from a computer device to access a service associated with a user account that provides digital entitlement management for the computer device through the user account based at least on a device identification of the computer device changing or a clean install of the operating system occurring, wherein the user account is associated with a device identification of the computer device;
accessing the user account associated with the device identification of the computer device;
retrieving a list of devices associated with the user account with available digital entitlements to be reactivated on the computer device or transferred to the computer device, wherein the user account establishes ownership of the available digital entitlements;
transmitting the list of devices to the computer device;
receiving an operating system license request to transfer a digital entitlement associated with a selected device identification from the list of devices to the computer device;
determining whether the transfer of the digital entitlement is valid;
generating an operating system license associated with the digital entitlement when the transfer is valid; and
transmitting the operating system license to the computer device.

16. The server of claim 15, wherein the list of devices is filtered based on one or more of a form factor of the devices and an operating system edition of the devices.

17. The server of claim 15, wherein the digital entitlement manager is further operable to transmit a notification rejecting the operating system request when the digital entitlement transfer is not valid.

18. The server of claim 17, wherein the digital entitlement transfer is not valid when the digital entitlement transfer exceeds one or more of a predefined user based limit, a predefined entitlement based limit, and a predefined device based limit.

19. The server, of claim 15, wherein determining whether the transfer of the digital entitlement is valid when the digital entitlement transfer is within one or more of a predefined user based limit, a predefined entitlement based limit, and a predefined device based limit.

20. The server of claim 15, wherein the digital entitlement manager is further operable to reassign the digital entitlement associated with the selected device to the device identification of the computer device.
